(19) United States
(12) Patent Application Publication
(10) Pub. No.: US 2007/0005204 A1
(43) Pub. Date: Jan. 4, 2007

(54) Vehicle-mounted data rewriting control system

(75) Inventors: Satoshi Yamamoto, Anjo-city (JP); Kazunori Okada, Chiryu-city (JP); Zen Takasu, Kariya-city (JP); Takafumi Nishiseko, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/476,635

(22) Filed: Jun. 29, 2006

(30) Foreign Application Priority Data
Jun. 30, 2005 (JP) 2005-192430

(51) Int. Cl. G01M 17/00; G06F 19/00

(52) U.S. Cl. 701/35; 701/33

(57) ABSTRACT

A vehicle-mounted data rewriting control system includes a master control system. In rewriting data in electronic control systems, the master control unit first obtains through radio communication rewrite data from an external management center which holds and manages VIN codes of vehicles and version information of control programs. The supplied data are temporarily stored in a memory unit of the master control system, and the stored rewrite data are determined for their properness. By using the stored rewrite data, the data in the electronic control systems are rewritten on condition that the rewrite data stored in the memory unit are proper.

### CROSS REFERENCE TO RELATED APPLICATION

This application is based on and incorporates herein by reference Japanese Patent Application No. 2005-192430 filed on Jun. 30, 2005.

### FIELD OF THE INVENTION

The present invention relates to a vehicle-mounted data rewriting control system, which rewrites or reprograms data such as control programs and control data for controlling vehicle-mounted equipment such as an engine. More particularly, the invention relates to a vehicle-mounted data rewriting control system, which executes the rewriting based on rewrite data supplied from an external unit through radio communication as data for rewriting.

### BACKGROUND OF THE INVENTION

A vehicle-mounted data rewriting control system of this kind is disclosed in, for example, U.S. Pat. No. 6,957,136 (JP-A-2004-28000). This vehicle-mounted data rewriting control system exchanges the data through radio communication with an external management center that stores and manages VIN codes (vehicle identification codes) of the vehicles and version data of control programs. The control programs and the control data stored in a rewritable region of a nonvolatile memory are rewritten based on the rewrite data supplied from the management center through radio transmission. Besides, it is first determined in radio communicating the rewrite data whether the communication environment with the management center is acceptable and whether the state of the vehicle is suited for executing the rewriting in order to maintain reliability in rewriting the control programs and the control data. After having confirmed that the above conditions are satisfied as a result of the above determination, the rewrite data are supplied through radio communication and the rewriting is executed based on the supplied data.

However, the vehicle-mounted data rewriting control system enhances reliability in rewriting the control programs and control data, such as:
the rewrite data are not supplied or the rewriting is not executed despite the communication environment to the management center is acceptable if the state of the vehicle is not suited for rewriting the data like the key switch of the vehicle is turned on; and
the rewrite data are not supplied or the rewriting is not executed if the vehicle is parked in a place of poor communication environment (e.g., underground parking lot) even if the state of the vehicle is suited for rewriting the data like the key switch of the vehicle is turned off.

Thus, the degree of freedom is greatly limited concerning the timing for obtaining the data and for effecting the rewriting.

Therefore, for example, US 2002/0019877A1 (JP-A-2002-157127) proposes a vehicle-mounted data rewriting control system equipped with a memory unit for temporarily storing the rewrite data at the time of rewriting the data (program).

This vehicle-mounted data rewriting control system first obtains the rewrite data through radio communication if the external communication environment is acceptable. It is, then, determined if the supplied data are proper. The data are stored in the memory unit if they are determined to be proper. Thereafter, when the state of the vehicle is suited for rewriting the data, the rewrite data stored in the memory unit are read out, and the data or programs are rewritten based on the above data. Therefore, the vehicle-mounted data rewriting control system greatly improves the degree of freedom concerning the timing for obtaining the data and for executing the rewriting, such as:
when the external communication environment is acceptable, the data are supplied through radio communication and are stored even if the state of the vehicle is not suited for rewriting the data like when the key switch of the vehicle is turned on; and
when the state of the vehicle is suited for rewriting the data like when the key switch of the vehicle is turned off, the control program and the control data are rewritten by using the rewrite data stored even if the vehicle is parked in a place of poor communication environment (e.g., underground parking lot).

The vehicle-mounted data rewriting control system determines whether the rewrite data supplied through radio communication are proper, and stores the data in the memory unit when they are proper. Therefore, the vehicle-mounted data rewriting control system surely guarantees the properness of the rewrite data supplied through the radio communication.

In this vehicle-mounted data rewriting control system, however, the properness of rewrite data stored in the memory unit may be affected in case the voltage of the vehicle-mounted battery varies accompanying the variation in the condition of the vehicle, such as turn on/off of the key switch (e.g., Ignition switch) of the vehicle at the time of storing the rewrite data in the memory unit. That is, the vehicle-mounted data rewriting control system does not necessarily highly guarantee the properness of the rewrite data stored in the memory unit or the properness of the control programs and control data that are rewritten.

### SUMMARY OF THE INVENTION

This invention has an object of providing a vehicle-mounted data rewriting control system which is capable of further improving reliability in rewriting data yet enhancing the degree of freedom concerning timing for obtaining rewrite data through radio communication and timing for executing the rewriting.

In order to achieve the above object, a vehicle-mounted data rewriting control system is so constructed as to rewrite, based upon rewrite data supplied from an external unit through radio communication, at least either a control program or control data for controlling vehicle-mounted equipment stored in a rewritable region of a nonvolatile memory. This system temporarily stores the rewrite data at the time of rewriting at least either the control program or the control data, determines the properness of the rewrite data stored and rewrites at least either the control program or the control data by using the rewrite data on condition that the rewrite data stored are determined to be proper.

This system enhances the degree of freedom concerning the timing for obtaining the data and the timing for executing the rewriting, such as:
when the external communication environment is acceptable, the data are supplied through radio communication and are stored even if the state of the vehicle is not suited for rewriting the data like when the key switch of the vehicle is turned on; and
when the state of the vehicle is suited for rewriting the data like when the key switch of the vehicle is turned off, the control program and the control data are rewritten by using the rewrite data stored even if the vehicle is parked in a place of poor communication environment (e.g., underground parking lot).

Besides, this system determines the properness of the rewrite data stored, and rewrites the control program or the control data by using the rewrite data stored on condition that the rewrite data stored are proper. This guarantees the properness of the data stored and, further, improves reliability in rewriting or reprogramming the data.

Here, the determination of properness may be to determine whether a particular rule set in advance for the data themselves such as checksum is satisfied in a state where the rewrite data have been stored. In this case, however, if the above particular rule is satisfied, it may happen that the data are determined to be proper even if an error is contained in the rewrite data that are stored. It is therefore desired that the determination of properness is executed based upon checking the verification of the rewrite data stored and of the verification data corresponding to the above data from the standpoint of maintaining properness of the control program and the control data that are rewritten. The verification may be checked on either the side of the vehicle (vehicle-mounted data rewriting control system) or at the source of transmitting the rewrite data.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a vehicle-mounted data rewriting control system inclusive of a relationship to a management center according to a first embodiment of the invention;

FIG. 2 is a block diagram illustrating, particularly, a master control system and an master control system in the vehicle-mounted data rewriting control system of the embodiment;

FIG. 3 is a sequence chart illustrating a procedure of a data rewrite processing executed in cooperation with the master control system and the master control system;

FIG. 4 is a flowchart illustrating processing for transmitting the rewrite data executed in the management center;

FIG. 5 is a chart schematically illustrating a shift of flag information operated accompanying the progress of the rewrite processing;

FIG. 6 is a flowchart illustrating a detailed procedure of the rewrite processing executed by the master control system;

FIG. 7 is a flowchart illustrating a procedure of data storage processing executed by the master control system;

FIG. 8 is a block diagram illustrating a memory structure in a memory unit which temporarily stores the rewrite data;

FIG. 9 is a flowchart illustrating processing for determining the properness executed by the master control system;

FIG. 10 is a flowchart illustrating processing for reporting the completion of rewrite preparation executed by the master control system;

FIG. 11 is a flowchart illustrating processing executed by the master control system at the time when an ignition switch is turned off;

FIG. 12 is a flowchart illustrating processing executed by the master control system at the time when the ignition switch is turned on;

FIG. 13 is a flowchart illustrating response processing in response to a user instruction;

FIG. 14 is a flowchart illustrating processing executed by the master control system being automatically started by a timer;

FIG. 15 is a flowchart illustrating processing for rewriting executed by the master control system;

FIG. 16 is a flowchart illustrating processing for determining the start by the master control system;

FIG. 17 is a sequence chart illustrating data rewrite processing executed by the vehicle-mounted data rewriting control system according to a second embodiment of the invention;

FIG. 18 is a flowchart illustrating processing executed by the management center when the vehicle-mounted data rewriting control system executes primary processing and secondary processing;

FIG. 19 is a flowchart illustrating processing executed by the master control system when the vehicle-mounted data rewriting control system of the embodiment executes the primary processing and the secondary processing;

FIG. 20 is a block diagram illustrating a memory that holds the rewrite data in the management center; and

FIG. 21 is a flowchart illustrating processing for checking the verification in the management center.

### DETAILED DESCRIPTION OF PREFERRED EMBODIMENT

(First Embodiment)

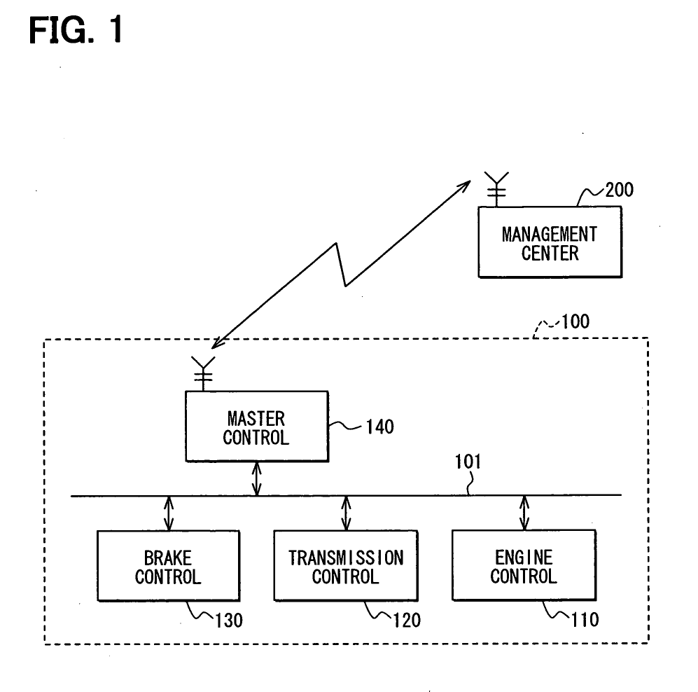

Referring to FIG. 1, a vehicle-mounted data rewriting control system 100 includes, a plurality of electronic control systems for controlling various vehicle-mounted equipment, and a master control system 140 for totally managing information (e.g., version information of control programs) concerned to these electronic control systems. These data rewriting control systems are electrically connected together through a communication bus 101 which constitutes a bus-type network system such as CAN (controller area network) and exchange a variety of data through the communication bus 101. Here, the plurality of electronic control systems include may include electronic control systems 110 to 130, such as:
an engine control system (engine ECU) 110 for controlling the injection of fuel into the engine mounted on the vehicle;
a transmission control system 120 for automatically changing over the speed-changing ratio of the transmission; and
a brake control system 130 for controlling the brake of the vehicle.

A variety of states of control and results of control are exchanged among the electronic control systems 110 to 130 though the communication bus 101. Usually, the electronic control systems 110 to 130 execute control programs stored in the nonvolatile memories incorporated therein based upon the information that is exchanged and upon the control data that have been stored therein in advance, and the above control operations are executed in cooperation. As for the transmission control system 120, for example, when a detection signal (binary signal) is taken in from a vehicle speed sensor provided on the output shaft of the transmission, the data that represents the vehicle speed information is formed based on the detection signal and is sent as serial data onto the communication bus 101. The serial data sent onto the communication bus 101 are taken in by, for example, the brake control system 130 which, then, uses the serial data for controlling the brake of the vehicle.

The master control system 140 is a unit that obtains the rewrite data from an external management center 200 that is holding and managing the VIN codes (vehicle identification codes) of vehicles and version information of control programs through radio communication, and rewrites the data in the electronic control systems 110 to 130 based on the data that are supplied.

That is, it becomes necessary to rewrite the contents of the control programs and the data such as control data in the electronic control systems 110 to 130 accompanying the version-up and correction of the control programs. In such a case, the master control system 140 first obtains, from the management center 200, the rewrite data (new data to be rewritten) used for rewriting the data (programs). Based upon the rewrite data that are supplied, the data in the electronic control systems 110 to 130 are rewritten in cooperation with the electronic control system for which the rewriting is to be executed. Upon mounting the data rewriting control system 100 on the vehicle, the control programs and the data such as control data in the electronic control systems 110 to 130 can be very easily maintained in the latest state.

In the case of the vehicle-mounted data rewriting control system 100 that obtains the rewrite data through radio communication, it is probable that reliability of the supplied data may drop depending upon a change in the communication environment relative to the management center 200 and the state of the vehicle.

In this embodiment, therefore, the master control system 140 in the vehicle-mounted data rewriting control system 100 first temporarily stores the rewrite data supplied through radio communication in its memory unit and determines the properness of the rewrite data that are stored at the time of rewriting the control programs and the control data. Thereafter, the rewriting is executed by using the rewrite data on condition that the rewrite data stored in the memory unit are proper, making it possible to improve reliability in rewriting (reprogramming) the data.

Besides, the above construction enhances the degree of freedom concerning the timing for obtaining the data and the timing for executing the rewriting, such as:
when the communication environment is acceptable relative to the management center 200, the data are supplied through radio communication and are stored in the memory unit even if the state of the vehicle is not suited for rewriting the data like when the key switch of the vehicle is turned on; and
when the state of the vehicle is suited for rewriting the data like when the key switch of the vehicle is turned off, the control programs and the control data are rewritten by using the rewrite data stored in the memory unit even if the vehicle is parked in a place of poor communication environment (e.g., underground parking lot).

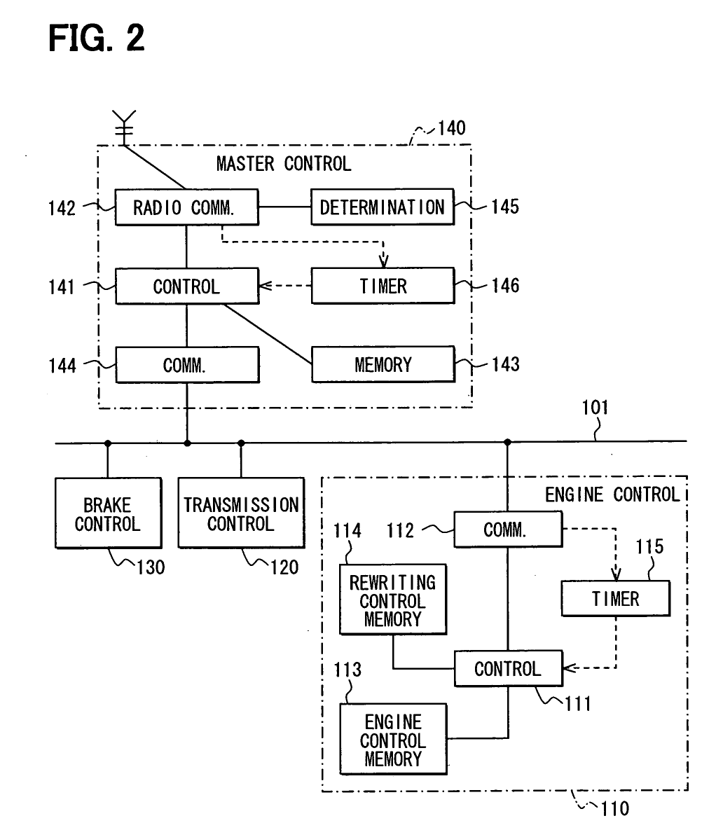

The master control system 140 and the master control system 140 in the vehicle-mounted data rewriting control system 100 are shown in detail in FIG. 2. Here, it is presumed that the data in the master control system 140 are to be rewritten.

Referring to FIG. 2, the master control system 140 is constructed with a control unit 141 for processing various information as a center. The control unit 141 executes a control program stored in a read-only memory incorporated in the control unit 141 itself, and exchanges various data relative to a radio communication unit 142, a memory unit 143 and a communication device 144, and executes an arithmetic operation based on these data.

Here, the radio communication unit 142 is a part that intermediates the exchange of data through radio communication between the control unit 141 and the management center 200. The radio communication unit 142 is connected to a communication state determining unit 145 which determines the quality of the communication state relative to the management center 200 based on such information as intensity of the radio waves received through an antenna. Depending upon the results of determination by the communication state determining unit 145, the radio communication is inhibited between the control unit 141 and the management center 200. The radio communication unit 142 is, further, connected to a timer 146 which automatically drives the control unit 141. When a signal for driving the control unit 141 is output from the management center 200, the radio communication unit 142 also executes processing of producing a drive signal to the timer 146 to promote the drive of the control unit 141.

The memory unit 143 is a data storage device that temporarily holds the rewrite data supplied through radio communication, and comprises a memory such as back-up RAM for holding the data in a nonvolatile state. The communication device 144 is for intermediating the exchange of data through the communication bus 101 between the control unit 141 and the master control system 140.

In rewriting the data in the master control system 140, the control unit 141 first obtains the rewrite data radio-transmitted from the management center 200 through the radio communication unit 142. Next, the supplied data are stored in the memory unit 143 and are, thereafter, determined for their properness. As a result, therefore, the data in the master control system 140 are rewritten by using the above data in cooperation with the master control system 140 on condition that the rewrite data stored in the memory unit 143 are proper. Specifically, the control unit 141 reads out the rewrite data from the memory unit 143, and transmits the data that are read out to the master control system 140 through the communication device 144.

The engine control system 110 is constructed with the control unit 111 as a center, the control unit 111 executing a variety of arithmetic operations based on information exchanged among a communication device 112, an engine control program memory 113 and a rewrite control program memory 114.

Here, the communication device 112 is a part that intermediates the exchange of data through the communication bus 101 between the control unit 111 and the master control system 140. The communication device 112, too, is connected to a timer 115 which automatically drives the control unit 111. When a signal for driving the control unit 111 is output from the master control system 140, the communication device 112 also executes processing of producing a drive signal to the timer 115 to promote the drive of the control unit 111.

The engine control program memory 113 is a part for storing the control program and data such as control data used for controlling the engine, and comprises an electrically rewritable nonvolatile memory such as flash memory or EEPROM.

The rewrite control program memory 114 comprises a suitable nonvolatile memory (e.g., EEPROM) storing the control program and data such as control data used by the control unit 111 for rewriting the data in the engine control program memory 113 in cooperation with the control unit 141 in the master control system 140.

In the above engine control system 110 as is well known, the control unit 111 takes in the operation information such as vehicle speed information sent onto the communication bus 101, and executes the control program stored in the engine control program memory 113 to control the engine.

Here, however, to rewrite the data in the engine control program memory 113, the control unit 111 takes in, through the communication device 112, the rewrite data that are sent onto the communication bus 101 from the master control system 140. Next, by using the thus supplied data, a control program in the rewrite control program memory 114 is executed to rewrite the data in the engine control program memory 113. In executing the communication between the engine control system 110 and the master control system 140, it is practically desired to conduct a suitable communication checking such as sum checking.

The above internal structure of the engine control system 110 is generally common to other electronic control systems 120 and 130.

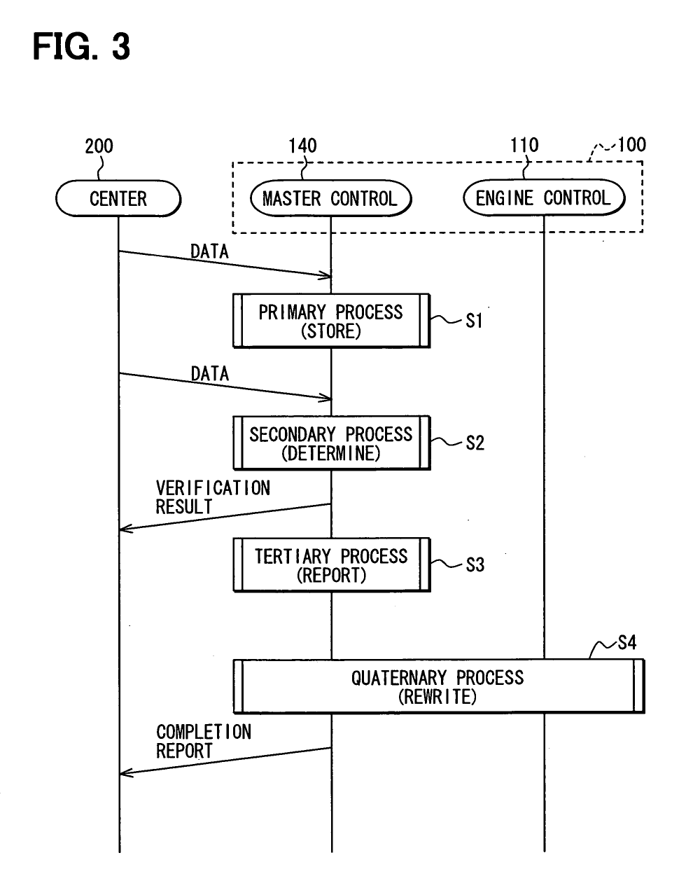

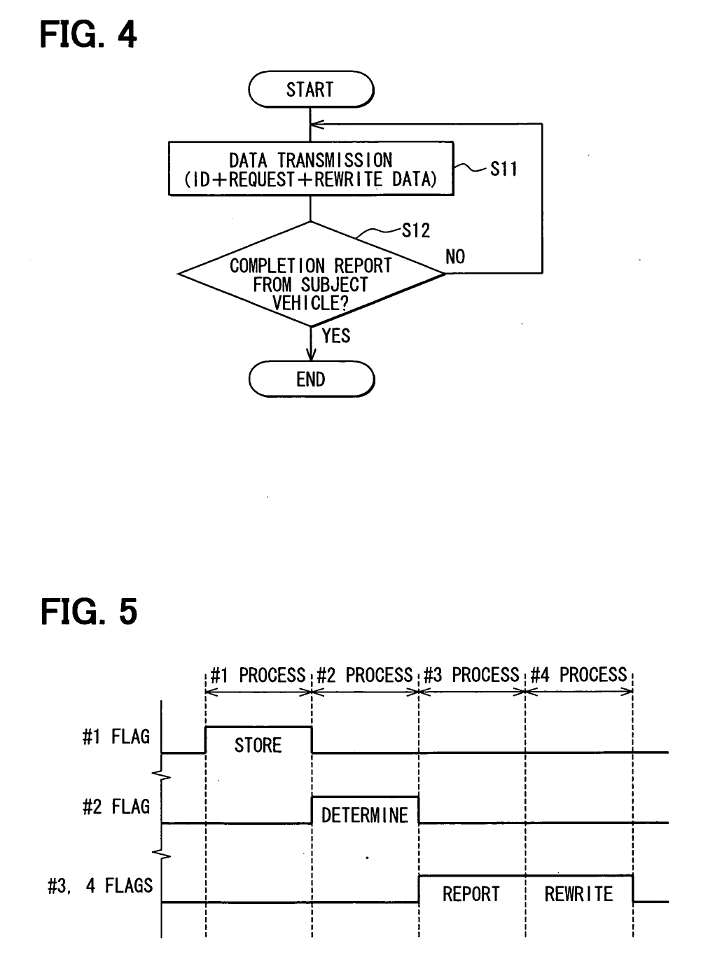

In executing the rewrite processing shown in FIG. 3, the management center 200 first executes the transmission processing according to a procedure shown in a flowchart of FIG. 4.

That is, as shown in FIG. 4, the management center 200 repetitively transmits the rewrite data to the data rewriting control systems 100 mounted on a vehicle until a rewrite completion report indicating the completion of rewriting the data in the master control system 140 is received from the vehicle for which the data are to be rewritten (steps S11 and S12). Here, in this embodiment, the transmission processing of the management center 200 is executed by packet communication, and the rewrite data are transmitted being divided in a unit of data block (unit of packet). The transmission processing, further, transmits an ID (VIN code or article number) for specifying the vehicle or the electronic control system for which the data are to be rewritten, and a notice requesting the rewriting of data (request for rewriting).

For the transmission processing, the control unit 141 in the master control system 140 of the vehicle-mounted data rewriting control system 100 receives the rewrite data radio-transmitted from the management center 200 as shown in FIG. 3, and executes a primary processing (#1 processing) for storing the data in the memory unit 143 (step S1). Next, based on the data transmitted again from the management center 200, secondary processing (#2 processing) is executed for determining the properness of the rewrite data stored in the memory unit 143 (step S2). Next, tertiary processing (#3 processing) is executed at step S300 for reporting (reporting) the user of the completion of preparation for rewriting the data in the master control system 140 on condition that the rewrite data stored in the memory unit 143 are proper. In response to the user's instruction for rewriting the data by the tertiary processing, a quaternary processing (#4 processing) is executed for rewriting the data in the master control system 140 in cooperation with the engine control system 110 (step S4). When the data in the engine control system 140 are rewritten upon the execution of a series of processing (primary processing to quaternary processing), the rewrite completion report reporting the completion of rewriting is transmitted to the management center 200 to end the rewrite processing.

In this embodiment, however, the rewrite processing (primary processing to quaternary processing) are executed in a manner as described below in response to the ID or rewrite request transmitted together with the rewrite data or based upon the following three kinds of flag information operated in a form illustrated in FIG. 5 every time when the rewrite data are transmitted from the management center 200.

Here, as will be described later, the following three kinds of flag information are stored in a backup RAM incorporated in the control unit 141 and are executed by the control unit 141.
A primary processing flag (#1 flag) operated in a form in synchronism with a period of executing the primary processing (step S1).
A secondary processing flag (#2 flag) operated in a form in synchronism with a period of executing the secondary processing (step S2).
Tertiary and quaternary processing flags (#3 and #4 flags) operated in a form in synchronism with periods of executing the tertiary and quaternary processing (steps S3 and S4).

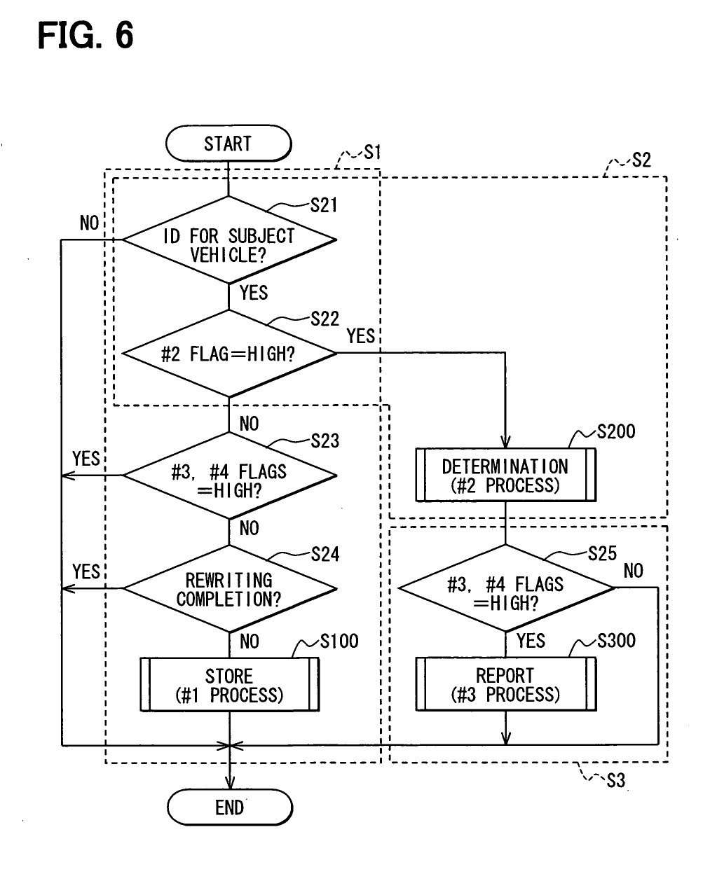

FIG. 6 is a flowchart illustrating a detailed procedure of the rewrite processing (primary processing to quaternary processing) executed based on the logic levels of these three kinds of flag information. These processing are executed every time when the data (data block) divided in a unit of packet are received.

That is, in the rewrite processing, the control unit 141 in the master control system 140 first confirms at step S21 whether the data (ID) from the management center 200 is specifying the subject vehicle, on which the data rewriting control system is mounted. When the ID is specifying the subject vehicle, reference is made successively at steps S22 and S23 to the logic levels of the secondary processing flag and of the tertiary and quaternary processing flags.

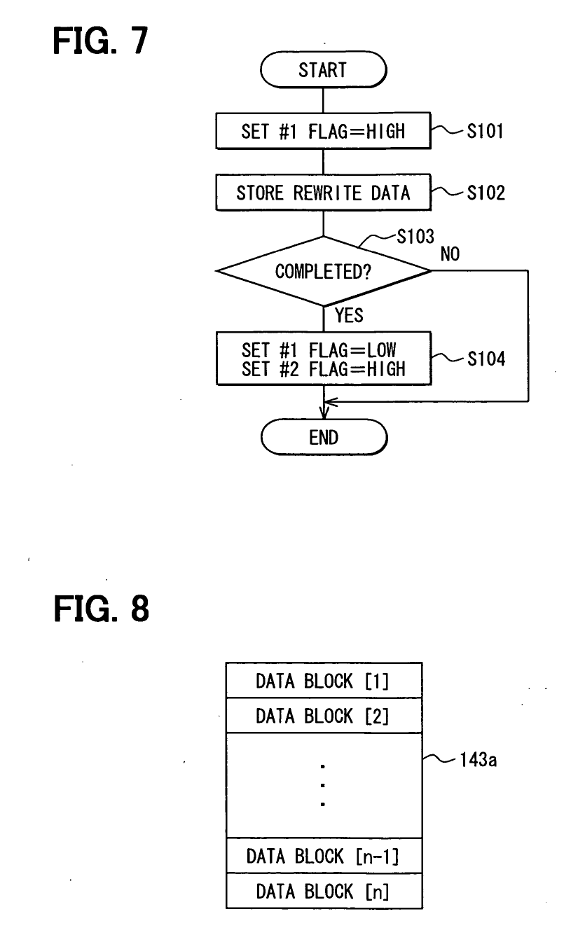

As a result, when the secondary processing flag, tertiary and quaternary processing flags all have a logic [L (low)[level, the control unit 141 shifts to processing of next step S24 as being in a condition where the primary processing (step S1) is to be executed as shown in FIG. 5. When it is determined at step S24 that the rewriting of data in the master control system 140 has not been completed, data storage processing is executed to store the received rewrite data in the memory unit 143 (step S100). Thus, the processing of steps S21 to S24 and step S100 are executed as the primary processing (step S1). Details of the data storage processing (step S100) will be described later with reference to FIG. 7.

In the processing of the step S23, however, when the tertiary and quaternary processing flags have a logic [H (high)[level, the control unit 141 ends the control upon having confirmed that the tertiary and quaternary processing flags have the logic high level as being in a condition where the tertiary processing or the quaternary processing is to be executed as shown in FIG. 5 above.

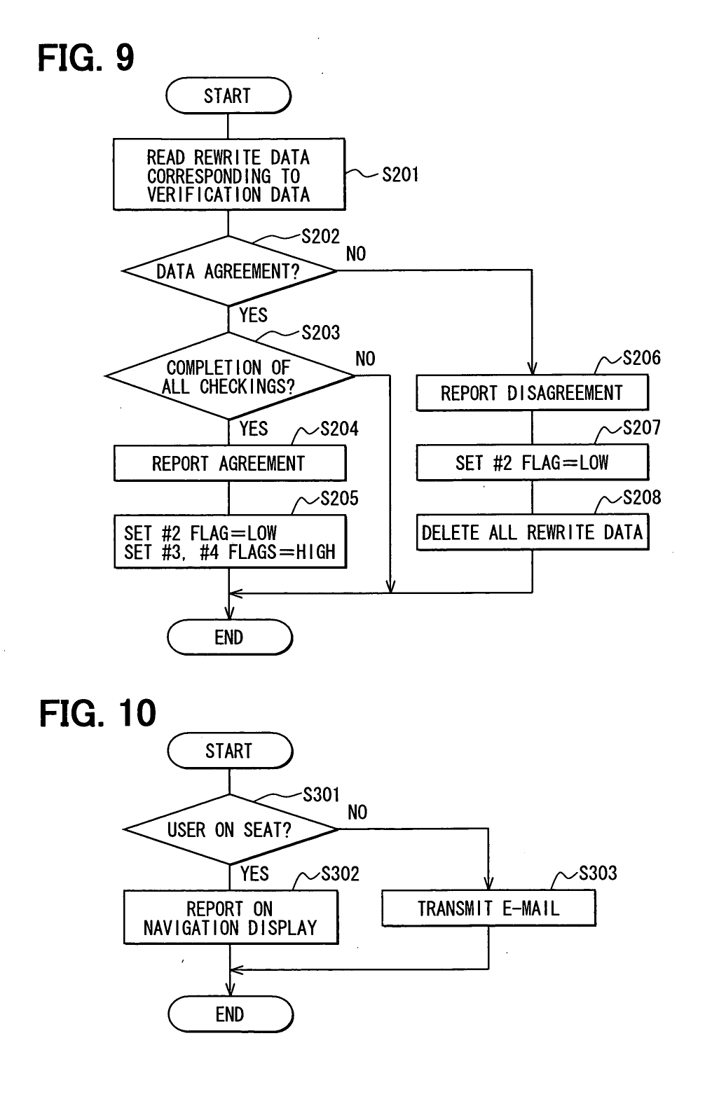

In the processing of step S22 above, on the other hand, when the secondary processing flag has the logic high level, the condition is such that the secondary processing (step S2) can be executed as shown in FIG. 5 above. In this case, therefore, the control unit 141 at next step S200 executes a properness-determining processing (secondary processing) for determining the properness of the rewrite data stored in the memory unit 143 based on the data received above. Thus, the processing of steps S21, S22 and S200 are executed as the secondary processing (step S2). Details of the properness-determining processing (step S200) will be described later with reference to FIG. 9.

After the processing of step S200 is executed, the control unit 141 confirms the logic levels of the tertiary and quaternary processing flags at step S25. When the tertiary and quaternary processing flags are of the logic high level, the control unit 141 at nest step S300 executes rewrite preparation completion report processing (tertiary processing) for reporting the user of the completion of preparation for rewriting the data in the master control system 140 based on that the rewrite data stored in the memory unit 143 are proper. Thus, the processing of steps S25 and S300 are executed as the tertiary processing (step S3). Details of the rewrite preparation completion report processing (step S300) will be described later with reference to FIG. 10.

Here, however, when the tertiary and quaternary processing flags have the logic low level at step S25, it means that the rewrite data stored in the memory unit 143 had been determined at step S200 to be not proper. In this case, therefore, the control unit 141 ends the control at a moment when it is confirmed that the tertiary and quaternary processing flags are of the logic low level.

The data storage processing executed as processing of step S100, the properness-determining processing executed as processing of step S200, and the rewrite preparation completion report processing executed as processing of step S300 will be described in further detail with reference to FIGS. 7, 9 and 10.

Referring first to FIG. 7, described below in detail is the procedure of the data storage processing (step S100).

In the processing (FIG. 6) at step S24, if it is determined that the processing for rewriting the data in the master control system 140 has not yet been completed, the master control system 140 executes the data storage processing for storing the received rewrite data in the memory unit 143 at step S100 as described above.

Specifically, as shown in FIG. 7, at the time of storing the rewrite data in the memory unit 143, the control unit 141 in the master data rewriting control system 140 first sets at step S101 the primary processing flag to assume the logic high level. Next, at step S102, the rewrite data transmitted being divided in a unit of data block (unit of packet) are stored in a memory region 143a in the memory unit 143 in a form shown in FIG. 8. Next, at step S103, it is determined if data blocks (data block [1] to data block [n]) of the rewrite data are all stored in the memory unit 143. As a result, when it is determined that the data blocks of the rewrite data have not all been stored in the memory unit 143, the data storage processing is once finished to stand by until a next data block is received by packet communication. In this case, the processing of steps S101 to S103 are repetitively executed every time when the rewrite data are received in a unit of data block until it is so determined that the data blocks of the rewrite data are all stored in the memory unit 143.

As a result of the above processing, when it is so determined that the data blocks (data block [1] to data block [n]) of the rewrite data are all stored in the memory unit 143 as shown in FIG. 8, the control unit 141 executes processing of step S104. At step S104, the data storage processing ends at a moment when the primary processing flag is set to assume the logic low level and the secondary processing flag is set to assume the logic high level.

By operating the primary processing flag and the secondary processing flag as described above, the control unit 141, next, executes the properness-determining processing (step S200) for determining the properness of rewrite data stored in the memory unit 143 as shown in FIG. 5 above. Here, in this embodiment, the control unit 141 receives the data transmitted again from the management center 200 as verification data that correspond to the rewrite data stored in the memory unit 143, and executes the properness-determining processing based on checking the verification of the received data and of the stored data.

Next, the properness-determining processing (step S200) will be described with reference to FIG. 9.

That is, in the processing of step S22 (FIG. 6), if the secondary processing flag assumes the logic high level, the master control system 140 at step S200 executes the properness-determining processing for determining the properness of the rewrite data stored in the memory unit 143 based on the received data.

Specifically, in determining the properness as shown in FIG. 9, the control unit 141 in the master control system 140 at step S201 first reads out from the memory unit 143, the data block of the above rewrite data corresponding to the data block of the received verification data. Next, at step S202, the received data block (verification data) is compared with the data block that is read out (rewrite data) (verify checking). As a result, when the two data blocks are in agreement, it is determined at step S203 whether the verify checking is completed for all data blocks (data block [1] to data block [n]) that constitute the rewrite data stored in the memory unit 143.

When it is determined at step S203 that the verify checking has not been completed, the properness-determining processing is once finished to stand by until the next data block is received by packet communication. That is, in this case, the processing of steps S201 to S203 are repetitively executed until it is determined that the verify checking is completed concerning all data blocks (data block [1] to data block [n]) that constitute the rewrite data stored in the memory unit 143.

Here, however, when it is determined at step S202 that the above two data blocks are not in agreement, the control unit 141 executes the processing of steps S206 to S208 at a moment when it is determined that these two data blocks are not in agreement. At step S206 first the fact that the above verification checkings were in disagreement (not in agreement) is reported to the management center 200. Next, at step S207, the secondary processing flag is set to assume the logic low level. Next, at step S208, the data blocks (data block [1] to data block [n]) stored in the memory unit 143 are all deleted. Through the above processing (steps S206 to S208), the control unit 141 executes the above rewrite processing (primary processing to quaternary processing) again starting with the data storage processing (primary processing).

On the other hand, when it is determined that the verification checking is completed concerning all data blocks (data block [1] to data block [n]) at step S203 as a result of repetitively executing the processing of steps S201 to S203, the control unit 141 executes the processing of next step S204. That is, the fact that the verification checkings are in agreement at step S204 is reported to the management center 200. Thereafter, the properness-determining processing ends at a moment when the secondary processing flag is set to assume the logic low level, and the tertiary and quaternary processing flags are set to assume the logic high level at step S205.

Thus, as the secondary processing flag and the tertiary and quaternary processing flags are set, the control unit 141 executes the rewrite preparation completion report processing (step S300) to report the user of the fact that the preparation is completed for rewriting the data in the master control system 140 as shown in FIG. 5 above.

Next, specifically described below with reference to FIG. 10 is the rewrite preparation completion report processing (step S200).

That is, in the processing (FIG. 6) at step S25, if it is now presumed that the above tertiary and quaternary processing flags assumes the logic high level, the master control system 140 executes at step S300 the rewrite preparation completion report processing to report the user of the completion of preparation for rewriting the data in the master control system 140 as described above.

Specifically, in reporting the user as shown in FIG. 10, the control unit 141 in the master control system 140 at step S301 first monitors the output from a seating sensor that detects whether the driver (user) is seated. The seating sensor may comprise, for example, a pressure sensor that detects the magnitude of pressure imparted to the seat when the driver is seated. As a result, when it is determined that the driver is seated on the seat based on the output from the seating sensor, the control ends at a moment when the user at step S302 is reported of the completion of preparation for rewriting the data in the master control system 140 through the display on a screen of a navigation system installed in the compartment.

Here, however, when it is determined at step S301 that the driver is not seated on the seat, the routine proceeds to processing of step S303. In the processing of step S303, the control ends at a moment when the user is reported of the fact that the preparation for rewriting the data in the master control system 140 is completed by the transmission of a mail (E-mail) to a cell phone that has been registered in advance. Specifically, the processing at step S303 is executed by the control unit 141 which transmits, to the management center 200, a signal of notice by mail (E-mail) through the radio communication unit 142. Namely, in this case, the management center 200 transmits the mail (E-main) to the cell phone that has been registered in advance based on the reception of the signals.

After the end of the rewrite preparation completion report processing, the control unit 141 basically stands by until rewriting the data is instructed by the user. The instruction by the user is effected by, for example, operating a switch of the navigation system or by transmitting, to the management center 200, a mail in reply to the above E-mail. Through the above operation, further, the user instructs rewriting the data in the master control system 140 or instructs canceling the rewriting of data. In this embodiment, the user is allowed to instruct the time for starting the rewriting for the vehicle-mounted data rewriting control system 100 as an embodiment for instructing the rewriting. That is, in this case, a timer time corresponding to the timing for starting the rewriting as instructed by the user is set to the timer 146 in the master control system 140.

In this embodiment, however, in order to more smoothly execute the rewriting of data in the master control system 140, the control unit 141 executes again the rewrite preparation completion report processing when no operation has been executed by the user at a moment when the Ignition switch of the vehicle is turned off and at a moment when the Ignition switch is turned on.

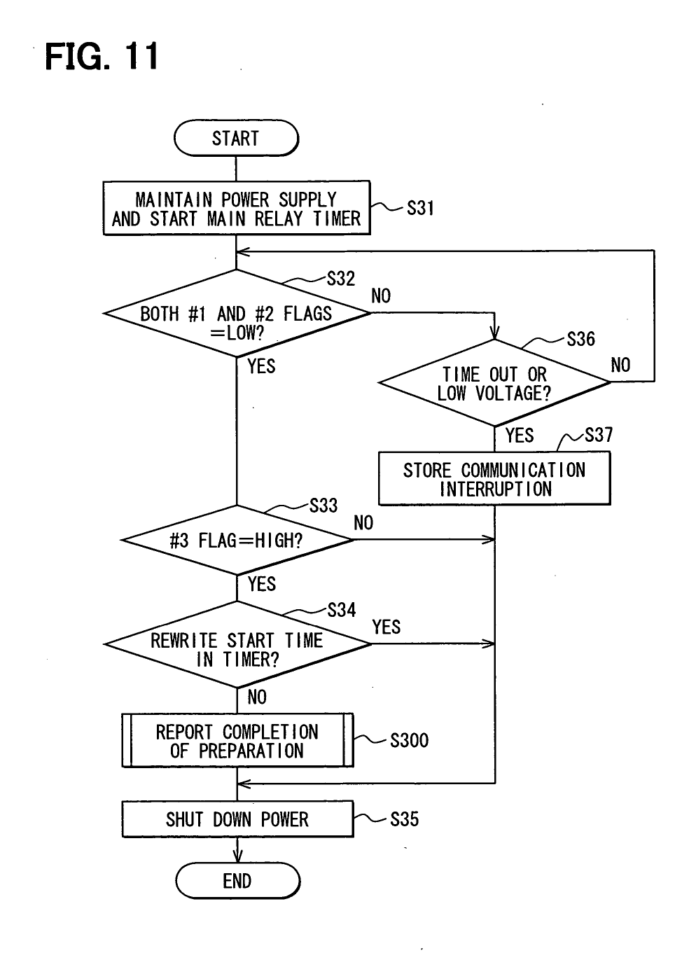

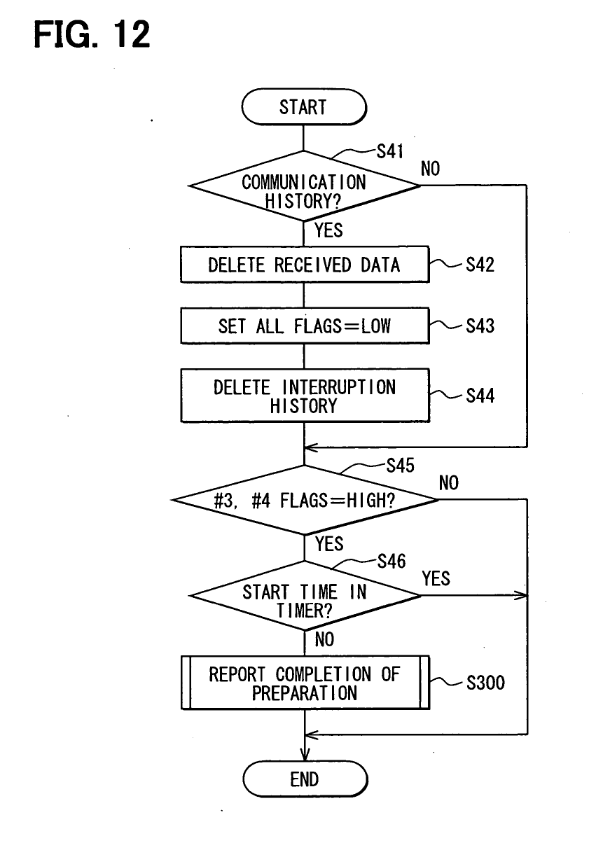

FIGS. 11 and 12 are flowcharts illustrating procedures of processing executed at moments when the ignition switch is turned off and turned on.

Described below with reference to FIG. 11 first is the processing at the moment when the ignition switch is turned off.

That is, if now the ignition switch is turned off, the control unit 141 in the master control system 140 at step S31 first maintains the state of being fed with electric power from the vehicle-mounted battery being controlled by a main relay. Further, the time is counted by the timer (main relay timer) in response to the start of the main relay control. Next, it is determined whether the timer time (moment for starting the rewriting of data) has been set to the timer 146 (step S34) on condition that the primary processing flag and the secondary processing flag are both assuming the logic low level and the tertiary and quaternary processing flags assume the logic high level (steps S32 and S33). As a result, when the timing for starting the rewriting of data has been set, the operation by the user has already been executed as described above. In this case, therefore, the control unit 141 ends the control at a moment when the electric power is no longer fed from the vehicle-mounted battery at step S35 as controlled by the main relay.

On the other hand, when the timing for starting the rewriting of data has not been set at step S34, it means that the operation has not yet been executed by the user. Therefore, the control unit 141 executes again the rewrite preparation completion report processing (step S300) for reporting the user of the completion of preparation for rewriting the data in the master control system 140. Next, at step S35, the control ends at a moment when the electric power is no longer fed from the vehicle-mounted battery as controlled by the main relay. Through the above processing, the data are rewritten more smoothly in the master control system 140.

On the other hand, when the tertiary and quaternary processing flags assume the logic low level at step S33, the above three kinds of flag information are all assuming the logic low level, and the rewrite processing (primary processing to quaternary processing) has not been executed yet as shown in FIG. 5 above. Therefore, the control unit 141 executes the processing of step S35 without executing the processing of steps S34 and S300, and ends the control at a moment when the electric power is no longer fed from the vehicle-mounted battery as controlled by the main relay.

Further, when either the primary processing flag or the secondary processing flag assumes the logic high level at step S32, the data storage processing (step S100) or the properness-determining processing (step S200) is ready to be executed. That is, the ignition switch is turned off so that the control unit 141 receives the rewrite data or the verification data irrespective of the radio communication which is taking place with the management center 200.

In this case, therefore, the control unit 141 in the master control system 140 maintains the state of feeding the electric power from the vehicle-mounted battery for a period of time required for the data communication, and continues the data storage processing (step S100) and the properness-determining processing (step S200). Thus, the data storage processing (step S100) and the properness-determining processing (step S200) are suitably executed irrespective of the operation of the Ignition switch.

Here, however, it may often be desirable to interrupt the communication of data from the standpoint of maintaining reliability of the rewrite processing (primary processing to fourth processing) such as when the vehicle is parked in a place of poor communication environment (e.g., underground parking lot) or when the supply voltage of the vehicle-mounted battery is lower than a lower-limit value which is necessary for executing the communication. Therefore, when the time counted by the main relay timer exceeds or times out an upper-limit time that has been set as a time required for the data communication or when the voltage of the vehicle-mounted battery becomes lower than the low-limit value, the control unit 141 interrupts the data communication at step S36. Thereafter, a communication interruption history representing the interruption of data communication is stored in the backup RAM incorporated in the control unit 141 (step S37), and the control ends at a moment when the electric power is no longer fed from the vehicle-mounted battery as controlled by the main relay (step S35). As will be described later, through the above processing (steps S35 to S37), the control unit 141 executes again the rewrite processing (primary processing to quaternary processing) starting with the data storage processing (primary processing).

Next, described below with reference to FIG. 12 is a processing executed at a moment when the Ignition switch is turned on.

Here, when the ignition switch is turned on, the control unit 141 in the master control system 140 first determines at step S41 if the above communication interruption history has been stored in the backup RAM incorporated in the control unit 141. As a result, if it is determined that the above history has been stored, the control unit 141 interrupts the communication with the management center 200 and successively executes the processing of steps S42 to S44 in order to execute again the rewrite processing (primary processing to quaternary processing) starting with the data storage processing (primary processing).

That is the control unit 141 first deletes at step S42 the data (rewrite data and the verification data) stored in the memory unit 143 received through communication with the management center 200. Next, after the primary processing flag, secondary processing flag, and tertiary and quaternary processing flags are set to assume the logic low level (step S43), the communication interruption history is deleted from the backup RAM incorporated in the control unit 141 (step S44). Through the processing of these steps S42 to S44, the control unit 141 executes again the rewrite processing (primary processing to quaternary processing) as described above starting with the data storage processing (primary processing). Thereafter, it is determined at step S45 if the tertiary and quaternary processing flags assume the logic high level. The control ends at a moment when it is determined that the tertiary and quaternary processing flags assume the logic low level.

At step S41, however, when the communication interruption history has not been stored in the backup RAM incorporated in the control unit 141, the control unit 141 executes the processing of step S45 without executing the processing of steps S42 to S44. When it is determined at step S45 that the tertiary and quaternary processing flags assume the logic high level, it is determined at step S46 if a timing for starting the rewriting of data has been set to the timer 146. When the timing for starting the rewriting of data has not been set, the control unit 141 determines that the operation has not been executed yet by the user, and executes again the rewrite preparation completion report processing (step S300) to report the user of the completion of preparation for rewriting the data in the master control system 140. Through the above processing, the data can be more smoothly rewritten in the master control system 140.

On the other hand, when the timing for starting the rewriting of data has been set at step S46, the control unit 141 ends the control assuming that the setting has been executed already by the user.

When the operation is executed by the user after having repetitively executed the rewrite preparation completion report processing (step S300), the control unit 141 next executes the response processing (quaternary processing) in response to the instruction by the user.

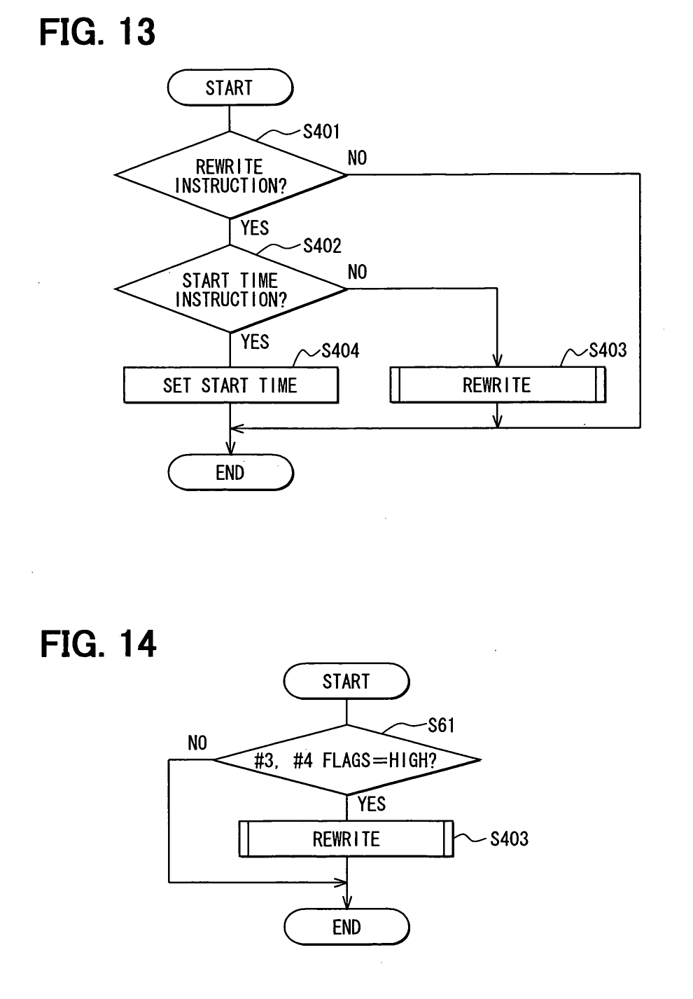

FIG. 13 is a flowchart illustrating a procedure of the response processing in response to the user instruction. This processing will be described next with reference to FIG. 13.

To carry out this processing, the control unit 141 in the master control system 140 first determines at step S401 whether the operation by the user is to instruct the rewriting of data in the master control system 140. When the operation by the user is to cancel the rewriting of data, the control ends to postpone the rewriting of data in the master control system 140.

On the other hand, when it is determined at step S401 that the operation by the user is to rewrite the data in the master control system 140, the control unit 141 determines at step S402 whether it has been requested (instructed) to set the timing for starting the rewriting of data. When it is determined that there is no instruction for setting the timing for starting the rewriting of data, the control unit 141 at step S403 executes the rewrite execution processing for rewriting the data in the master control system 140 by using the rewrite data stored in the memory unit 143.

On the other hand, when it is determined at step S402 that the timing for starting the rewriting of data has been set, the control unit 141 at step S404 sets a timer time to the timer 146 relying upon the timing of starting the rewriting instructed by the user. Thus, the control unit 141 executes the rewrite execution processing (step S403) being automatically driven by the timer 146. Specifically as shown in FIG. 14, if the timer time that was set above elapses, the control unit 141 is automatically driven by the timer 146 to execute the rewrite execution processing (step S403) on condition that the tertiary and quaternary processing flags assume the logic high level (step S61).

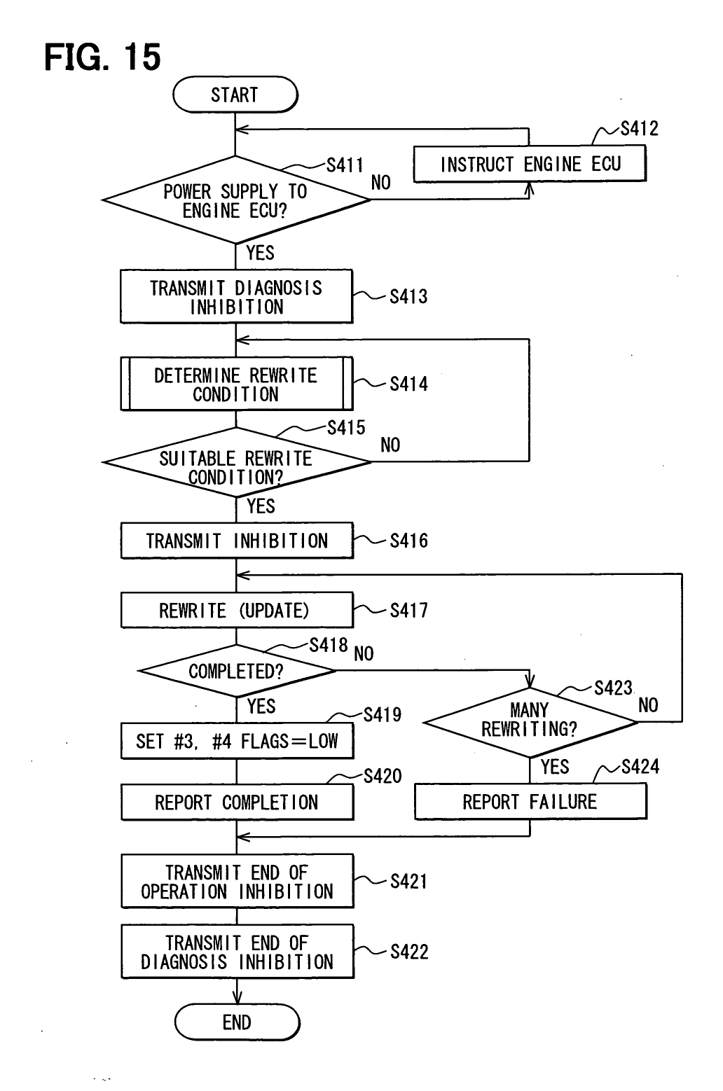

FIG. 15 is a flowchart illustrating a procedure of the processing for executing the rewrite execution processing. This processing will be described next with reference to FIG. 15.

When it is determined at step S402 (FIG. 13) that there has been specified no timing for starting the rewriting or is determined at step S61 (FIG. 14) that the tertiary and quaternary processing flags assume the logic high level, the master control system 140 executes at step S403 the rewrite execution processing.

In conducting the rewrite execution processing as shown in FIG. 15, the control unit 141 in the master control system 140 first determines at step S411 whether the electric power has been fed to the control unit 111 in the master control system 140 for which the data are to be rewritten. When the control unit 111 has not been fed with the electric power, an instruction is output to the master control system 140 to drive the control unit 111 (step S412) until the control unit 111 is fed with the electric power.

When it is determined at step S411 that the master control system 140 is automatically driven by the timer 115 and that the control unit 111 has been fed with the electric power, the control unit 141 at step S413 produces an instruction to the master control system 140 to inhibit the execution of a diagnosis processing.

In this embodiment, the master control system 140 executes a troubleshooting processing (diagnosis processing) for vehicle-mounted equipment that is to be controlled being driven by the control unit 111. Concerning this point in this embodiment, an instruction is output at step S413 to inhibit the execution of the diagnosis processing at a moment when the control unit 111 is driven by the timer 115 in the master control system 140. This avoids the rewrite execution processing for rewriting the data in the master control system 140 from being executed in parallel with the troubleshooting processing, and the rewrite processing is executed more reliably.

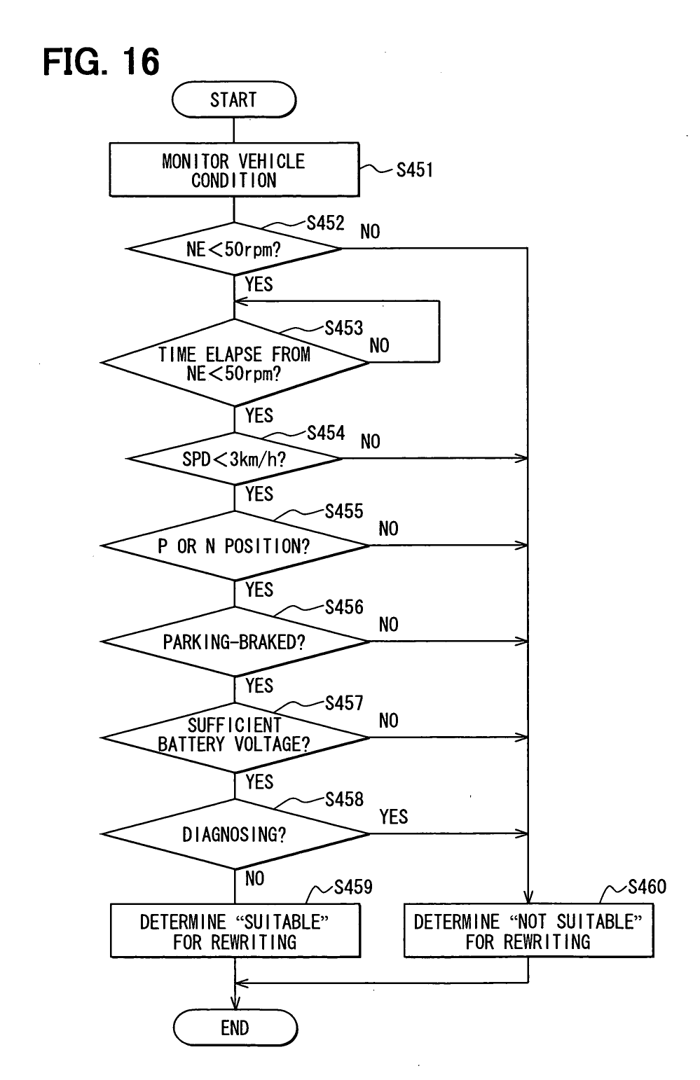

Besides, in this embodiment, the control unit 141 at step S414 determines for starting whether the state of the vehicle is suited for rewriting the data, and starts the data rewrite execution processing when it is determined that the vehicle is in the state suited for rewriting the data. Therefore, the data rewrite execution processing can be executed more reliably when the vehicle is in a state suited for rewriting the data. The determination for start (step S414) is repeated until the state of the vehicle turns out to be suited for rewriting the data (step S415). The determination for start will be described later with reference to FIG. 16.

As a result of determining for start, when it is determined that the state of the vehicle is suited for rewriting the data (step S415), the control unit 141 next sends to the user at step S416 a notice requesting him to inhibit the operation of the vehicle-mounted engine. This notice, too, is executed by transmitting an E-mail to a cell phone that has been registered in advance. After having the user reported, the data in the master control system 140 are rewritten in cooperation with the master control system 140 (control unit 111) (step S417). A detailed example of rewriting is as described above with reference to FIG. 2.

After having rewritten (reprogrammed) the data in the master control system 140 (step S418), the control unit 141 at step S419 operates the tertiary and quaternary processing flags to assume the logic low level. Next, at step S420, the above rewrite completion report (FIG. 3) is transmitted to the management center 200. Therefore, the management center 200 interrupts the transmission processing (FIG. 4) to the master control system 140. Thereafter, the control unit 141 notifies the user of the end of inhibition of operation of the vehicle-mounted engine (step S421), and ends the control at a moment of having output an instruction for ending the inhibition of the diagnosis processing to the master control system 140 (step S422).

On the other hand, when it is determined at step S418 that the rewriting (reprogramming) of data in the master control system 140 has not been completed, the processing at step S417 is repeated until the rewriting of data is completed (step S423). At step S423, however, when the number of times of executing the processing of step S417 exceeds a preset upper limit value, the above series of processing (primary processing to quaternary processing) are interrupted, and this fact is reported to the management center 200 (step S424). Thereafter, the control ends after having successively executed the processing of steps S421 and S422.

FIG. 16 is a flowchart illustrating a procedure of the processing of the determination for start executed at step S414 by the master control system 140. Next, determination for start will be described with reference to FIG. 16.

In determining the start, the control unit 141 in the master control system 140 first monitors at step S451 the outputs from various vehicle-mounted sensors representing vehicle condition. Based on the outputs monitored by the sensors, processing of the following steps S452 to S460 are executed to determine the start.

Specifically, the control unit 141 at step S452 determines whether the running speed SPD of the engine is smaller than 50 rpm (substantially zero). When it is determined that the engine speed is not smaller than 50 rpm, the control unit 141 takes it that the above control (engine control) might have been executed by using the control program stored in the engine control program memory 113, and determines at step S460 that the state of the vehicle is not suited for rewriting the data.

On the other hand, when it is determined at step S452 that the engine rotational speed NE is not lower than 50 rpm, the control unit 141 at step S453 stands by until a preset time elapses from a moment when the engine rotational speed has become lower than 50 rpm (substantially zero). That is, when the rotational speed becomes zero accompanying the halt of operation of the vehicle-mounted engine, the control unit 111 in the engine control system 110 of the vehicle executes the after-processing such as storing the data related to learned values in the backup RAM (nonvolatile memory) incorporated in the control unit 111 until the operation of the next time. In this embodiment, therefore, the control unit 111 stands by from a moment when the engine rotational speed has become smaller than 50 rpm (substantially 0) until when a preset time elapses to avoid the after-processing from being executed in parallel with the rewriting of data in the engine control system 110.

After the end of the after-processing, the control unit 141 determines at the following steps S454 to S458 if the logical AND conditions are satisfied:
(a) The vehicle speed SPD is lower than 3 km/h (substantially zero)(step S454);
(b) The shift position is either the parking position P or the neutral position N (step S455);
(c) The parking brake is applied (step S456);
(d) The voltage of the vehicle-mounted battery is not lower than a lower-limit value necessary for rewriting the data in the engine control system 110 (step S457);
(e) None of the data rewriting control systems in the vehicle-mounted data rewriting control system 100 inclusive of the engine control system 110 are executing the troubleshooting processing (diagnosis processing)(step S458).

When it is determined at steps S454 to S458 that the logical AND of these conditions (a) to (e) are satisfied, the control unit 141 so determines that the vehicle is in the state suited for rewriting the data (step S459). The conditions (a) to (c) are for making sure whether the safety of the vehicle is maintained, and the conditions (d) and (e) are for rewriting the data in the engine control system 110 highly reliably. In successively executing the processing of these steps S454 to S458, therefore, when even any one of the conditions (a) to (e) is determined to have not been satisfied, the control unit 141 shifts the routine to step S460 at a moment when it has rendered the above determination, and so determines that the vehicle is not in the state suited for rewriting the data.

According to the vehicle-mounted data rewriting control system of this embodiment, the following advantages are provided.
(1) In rewriting the control program or the control data in the engine control system 110, the rewrite data supplied through radio communication are temporarily stored in the memory unit 143. Thereafter, the above control program and the control data are rewritten by using the rewrite data on condition that the rewrite data stored in the memory unit 143 are normal. This enhances the degree of freedom concerning the timing for obtaining the rewrite data through radio communication and the timing for executing the rewriting, and further improves reliability in rewriting the data.
(2) Properness of the rewrite data stored in the memory unit 143 is determined based upon checking the verification of the rewrite data and of the verification data corresponding to the above data, making it possible to more properly execute the above rewrite processing (primary processing to quaternary processing).
(3) Verification is checked for every divided data upon every receipt of data transmitted being divided in a unit of data block (packet). It is, therefore, allowed to render the determination that the rewrite data stored in the memory unit 143 are lacking properness at a moment when the two data blocks are not in agreement prior to receiving all of the data blocks that constitute the verification data.
(4) When the ignition switch is turned off, the master control system 140 maintains the state of feeding the electric power from the vehicle-mounted battery for a period of time required for communicating the data while the communication is being executed relative to the management center 200. Irrespective of the operation of the Ignition switch, therefore, the rewrite data are reliably received and are stored in the memory unit 143.
(5) The master control system 140 holds in the backup RAM (nonvolatile memory) the history information (communication interruption history) representing that feeding of power is interrupted due to the interruption of electric power from the vehicle-mounted battery during the communication with the management center 200. Due to this history information, it is made possible to delete the rewrite data stored in the memory unit 143 and to receive again the deleted rewrite data.
(6) Upon rewriting (reprogramming) the data in the engine control system 110 based upon the rewrite instruction from the user, it is made possible to avoid the operation of the key switch of the vehicle during the reprogramming and to reliably rewrite the data such as control programs and control data for controlling the vehicle-mounted equipment.
(7) When the data have not been rewritten in the engine control system 110, the rewrite preparation completion report processing (step S300) is executed again at a moment when the ignition switch is turned off and at a moment when the Ignition switch is turned on. Therefore, the data can be rewritten (reprogrammed) more smoothly.
(8) When the operation is to rewrite the data in the engine control system 110, a request of inhibiting the operation of the vehicle-mounted engine is reported to the user. This favorably avoids the operation of a key switch of the vehicle during the reprogramming, and the data in the engine control system 110 can be more reliably rewritten.
(9) The master control system 140 is provided with the timer 146 to drive the control unit 141 upon the elapse of a timer time (timing for starting the rewriting) set by the user. Upon being thus driven, the control unit 141 in the master control system 140 executes the rewrite execution processing (step S403) for rewriting the data in the master control system 140 on condition that the rewrite data stored in the memory unit 143 are proper. Therefore, the timing for rewriting the data can be suitably selected (instructed) by the user. Further, when the vehicle-mounted engine is not in operation and the key switch of the vehicle is turned off (when the vehicle is in the state suited for rewriting the data), the control unit 141 in the master control system 140 is automatically driven to execute the rewriting; i.e., the data can be rewritten highly reliably.
(10) When it is determined that the rewrite data stored in the memory unit 143 are proper at a moment when the control unit 141 in the master control system 140 is driven by the timer 146, the troubleshooting processing (diagnosis processing) for the vehicle-mounted equipment is inhibited from being executed at a time when the control unit 141 is automatically driven. Thus, the rewrite processing is avoided from being executed in parallel with the troubleshooting diagnosis, and the rewrite processing (primary processing to quaternary processing) can be more reliably executed.
(11) Rewriting the data in the engine control system 110 is postponed in response to a canceling instruction from the user. Therefore, the user is allowed to easily maintain the chance of using the vehicle.
(12) In rewriting the data in the engine control system 110, it is determined for starting whether the vehicle is in a state which is suited for rewriting the data. The data in the engine control system 110 are rewritten by using the rewrite data stored in the memory unit 143 on condition that the state of the vehicle is determined to be suited for rewriting the data. Therefore, the data can be rewritten more reliably when the vehicle is in the state that is suited for rewriting the data.
(13) The control unit 141 stands by from a moment when the engine rotational speed becomes smaller than 50 rpm (substantially zero) until when a preset period of time elapses to avoid the rewriting of data in the master control system 140 in parallel with the after-processing described above, enabling the data to be rewritten more reliably.
(14) Since the master control system 140 is equipped with the radio communication unit 142 and the memory unit 143, the rewrite data supplied through radio communication can be stored in the memory unit 143 without using the communication bus 101.
   (Second Embodiment)

Next, the vehicle-mounted data rewriting control system according to a second embodiment will be described. Like the vehicle-mounted data rewriting control system of the first embodiment (FIG. 1), the vehicle-mounted data rewriting control system of this embodiment, too, includes, a plurality of electronic control systems for distribution controlling various vehicle-mounted equipment, and a master control system for totally managing information concerned to these electronic control systems. Communication is conducted among the data rewriting control systems through a bus-type network system. Further, the internal structures of the data rewriting control systems provided for the vehicle-mounted data rewriting control system, too, are mostly the same as those of the first embodiment (FIG. 2). In rewriting the control program and the control data, further, the second embodiment is mostly the same as the first embodiment in regard to that the master control system in the vehicle-mounted data rewriting control system executes such processing that:

the rewrite data supplied through radio communication are temporarily stored in the memory unit 143, and the rewrite data that are stored are determined for their properness; and

the data are rewritten (reprogrammed) in the data rewriting control system for which the data are to be rewritten by using the rewrite data on condition that the above stored rewrite data are proper.

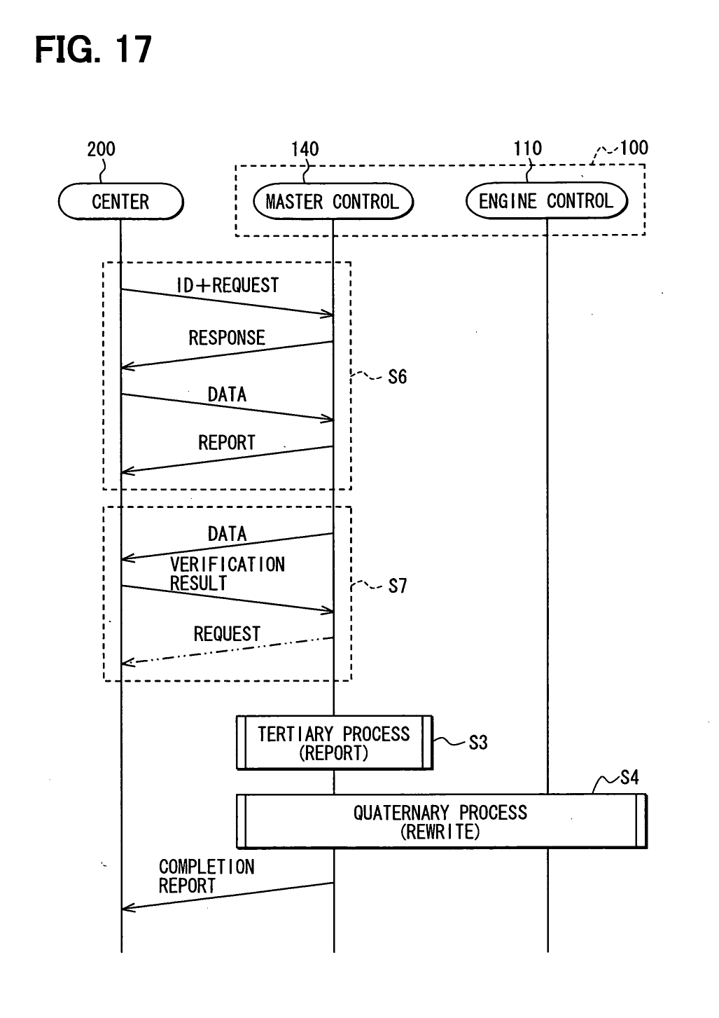

In this embodiment, however, a series of processing (primary processing to quaternary processing) are not the same, which are for rewriting the data in the master control system 140 for which the data are to be rewritten as shown in FIG. 17 in comparison with FIG. 3. That is, the vehicle-mounted data rewriting control system 100 of this embodiment executes the primary processing (step S6) for storing the rewrite data in the memory unit 143 and the secondary processing (step S7) for determining the properness of the rewrite data based on information shown in FIG. 17 exchanged relative to the management center 200.

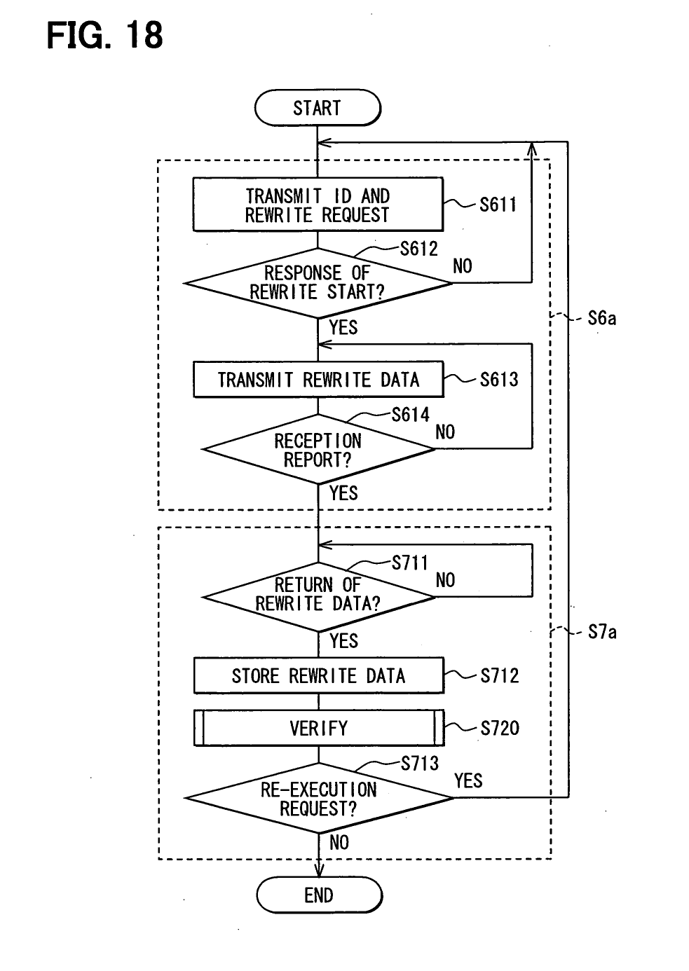

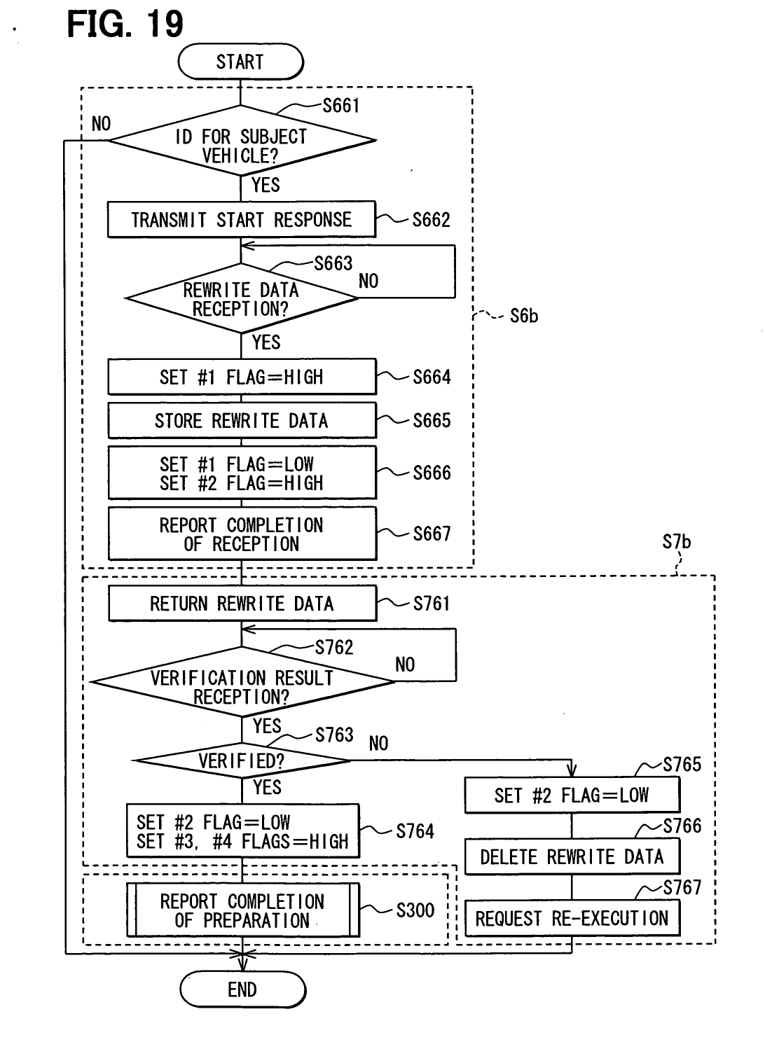

FIGS. 18 and 19 are flowcharts illustrating procedures of processing executed by the management center 200 and by the master control system 140, respectively, when the vehicle-mounted data rewriting control system 100 executes the primary processing and the secondary processing (steps S6 and S7). Next, the primary processing and the secondary processing will be described (steps S6 and S7) with reference to FIGS. 17 to 19.

First, described below with reference to FIGS. 17 and 18 are the primary processing and the secondary processing (steps S6a and S7a) when viewed from the management center 200, which are included in the above-mentioned primary processing and the secondary processing (steps S6 and S7).

Referring to FIGS. 17 and 18, the management center 200 at step S611 first transmits an ID for specifying the vehicle (data rewriting control system) for which the data are to be rewritten and a notice (request for rewrite) requesting the rewrite of data in the engine control system 110 to the master control system 140 in the vehicle-mounted data rewriting control system 100. The processing at step S611 is repeated until a start response is received from the master control system 140 permitting the execution of rewriting the data to be started (step S612).

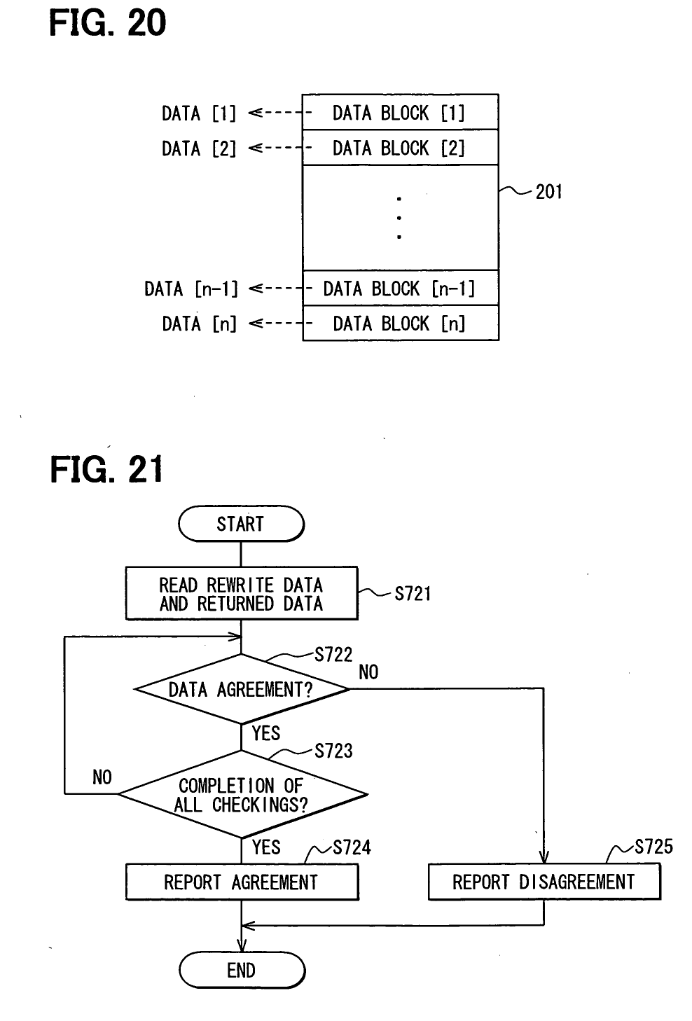

Next, at step S613, in response to the start transmitted from the master control system 140, the management center 200 transmits the rewrite data to the master control system 140 by packet communication. That is, as shown in FIG. 20, the management center 200 holds the rewrite data in a first region 201 of a predetermined memory in a unit of data block (data block [1] to data block [n]). In this embodiment, too, the rewrite data (transmission data [1] to transmission data [n]) are transmitted in a unit of data block (unit of packet). In this embodiment, however, the master control system 140 at step S614 repetitively executes the processing of step S613 until there is received a reception completion report representing the reception of rewrite data from the master control system 140, thereby to transmit all of data blocks of the rewrite data at one time.

The management center 200 executes the processing of steps S611 to S614 as the primary processing (step S6a) as viewed from the side of the management center 200. The rewrite data are thus stored in the memory unit 143 in the master control system 140. After the end of the processing of these steps S611 to S614, the management center 200 executes the secondary processing (step S7a) as viewed from the side of the management center 200.

That is, when the reception completion report is received at step S614, the management center 200 at step S711 stands by until the master control system 140 sends back or returns the rewrite data stored in the memory unit 143. Here, too, the rewrite data are transmitted being divided in a unit of data block (unit of packet). When the data block of the rewrite data are all sent back at step S711, the management center 200 effects processing of step S712.

At step S712, the rewrite data sent back from the master control system 140 are stored in a second region (not shown) of the predetermined memory in a form (unit of data block) illustrated in FIG. 20. At next step S720, the management center 200 usually uses the data that have been held in the first region 201 in advance as the verification data, and ends the control at a moment when the verification is checked for the verification data and for the rewrite data stored in the second region and is sent back.

Here, in the verification checking processing (step S720) as will be described later, the result of checking the verification is transmitted to the master control system 140. Based on the result of checking the verification, therefore, the master control system 140 determines whether the rewrite data stored in the memory unit 143 are proper. As a result, the data in the master control system 140 are rewritten by using the rewrite data on condition that the data are proper. However, when it is so determined based on the transmission of result of verification checking that the rewrite data stored in the memory unit 143 are not proper, the master control system 140 requests the management center 200 to execute again the rewrite processing (primary processing to quaternary processing) starting with the primary processing (step S6) as shown in FIG. 17. In this case, therefore, the management center 200 executes again the processing starting with step S611 (step S713).

The management center 200 executes the processing of steps S711 to S713 and of step S720 as the secondary processing (step S7a) as viewed from the side of the management center.

Next, described below with reference to FIGS. 17 and 19 are the primary processing and the secondary processing (steps S6b and S7b) as viewed from the side of the vehicle, which are included in the above primary processing and the secondary processing (steps S6 and S7).

Referring to FIGS. 17 and 19, if now the management center 200 transmits an ID (step S611) to specify the subject vehicle (data rewriting control system) for which the data are to be rewritten, the master control system 140 in the vehicle-mounted data rewriting control system 100 first confirms at step S661 whether the ID is specifying the subject vehicle. When the ID is specifying the subject vehicle, the master control system 140 transmits a start response (step S662) to the management center 200 to permit the start of execution of rewriting the data and stands by until the rewrite data are received (step S663).

When the rewrite data are all received at step S663, the rewrite data being transmitted in a form divided in a unit of data block, the master control system 140 at next step S664 sets the primary processing flag so as to assume the logic high level. In this embodiment, too, the flag information inclusive of the primary processing flag is stored in the backup RAM incorporated in the control unit 141 of the master control system 140, and is operated by the control unit 141. After having thus operated the primary processing flag, the master control system 140 at next step S665 stores the received rewrite data in the memory unit 143. After the rewrite data have been stored, the master control system 140 at step S666 operates the primary processing flag so as to assume the logic low level and operates the secondary processing flag so as to assume the logic high level. Next, the master control system 140 at step S667 transmits a reception completion report representing the completion of reception of the rewrite data to the management center 200.

The master control system 140 executes the processing of steps S661 to S667 as the primary processing (step S6b) as viewed from the side of the vehicle. After the end of the processing of these steps S661 to S667, the master control system 140 executes the secondary processing (step S7b) as viewed from the side of the vehicle.

That is, when the reception completion report is transmitted at step S667 to the management center 200, the master control system 140 at step S761 reads out the rewrite data stored in the memory unit 143 and transmits (returns) them to the management center 200. As described above, therefore, the management center 200 executes the verification checking (step S712) based on the rewrite data returned or sent back from the master control system 140.

Therefore, the master control system 140 stands by until the result of verification checking by the management center 200 is received (step S762), and determines whether the rewrite data stored in the memory unit 143 are proper based on the received result of verification checking (step S763). When it is determined that the verification checking is in agreement and the rewrite data stored in the memory unit 143 are proper, the master control system 140 at step S764 operates the secondary processing flag so as to assume the logic low level and sets the tertiary and quaternary processing flags so as to assume the logic high level. After having thus operated the secondary processing flag and tertiary and quaternary processing flags, the master control system 140 at next step S300 executes the rewrite preparation completion report processing (tertiary processing) to report the user of the completion of preparation for rewiring the data in the master control system 140.

When it is determined at step S763 that the verification checking is not in agreement and the rewrite data stored in the memory unit 143 are not proper, the master control system 140 at step S765 sets the secondary processing flag to assume the logic low level. That is, in this case, the rewrite data stored in the memory unit 143 are deleted (step S766), and the management center 200 is requested to execute again the rewrite processing (primary processing to quaternary processing) starting with the primary processing (step S6).

The master control system 140 executes the processing of these steps S761 to S767 as the secondary processing (step S7b) as viewed from the side of the vehicle. Thereafter as also shown in FIGS. 17 and 19, the tertiary processing and the quaternary processing (steps S3 and S4) are successively executed like in the above first embodiment to rewrite the data in the master control system 140.

FIG. 21 is a flowchart illustrating a procedure of the processing for checking the verification (step S720) executed in the management center 200.

In executing the processing, the management center 200 at step S721 first reads out the rewrite data stored in the second region of the predetermined memory and are sent back and, further, reads out the data stored in the first region 201 (FIG. 20) of the memory. At next step S722, the data read out from the first region 201 are used as verification data, and are compared with the rewrite data that are sent back in a unit of data block (verification checking). When the two data blocks are in agreement, it is determined at step S723 whether the verification checking is completed for all data blocks of the rewrite data that are sent back. When it is determined at step S723 that the verification checking has been completed, the management center 200 at next step S724 notifies the master control system 140 of the fact that the verification checking is in agreement.

On the other hand, when it is determined at step S723 that the verification checking has not been completed for all data blocks of the rewrite data that are sent back, the processing (verification checking) of step S722 is repetitively executed until it is determined that the verification checking has been completed. Here, however, when it is determined at step S722 that the above two data blocks are not in agreement, the management center 200 ends the verification check processing at a moment when the fact that the verification checking is not in agreement is reported to the master control system 140 at step S725.

As described above, the vehicle-mounted data rewriting control system of the second embodiment, too, makes it possible to obtain the effects which are basically the same as, or equivalent to, the advantages (1) and (2) as well as (4) to (14) of the first embodiment and, further, to newly obtain the advantage described below.
(15) The rewrite data and the verification data are checked for their verification after the whole data (whole data blocks) have been stored in the predetermined memory. Therefore, when these two data contain different portions, it becomes easy to recognize those portions.
   (Other Embodiments)

The above embodiments can be put into practice by being modified in a manner as described below.

In transmitting the data from the management center 200, it is practically desired to also transmit a signal for automatically driving the control unit 141 by the timer 146 when the supply of electric power to the control unit 141 in the master control system 140 has been interrupted.

It is determined for starting whether the state of the vehicle is suited for rewriting the data after the passage of a preset period of time from the moment when the rotational speed has become 0 accompanying the halt of operation of the vehicle-mounted engine and relying upon the determination of whether the logical AND of the conditions (a) to (e) is satisfied. Here, in determining whether the vehicle is in the state which is suited for rewriting the data, however, the conditions (a) to (c) do not have to be necessarily determined concerning if the safety of the vehicle is maintained. Further, the determination for start may be carried out in any form. For example, it may be determined that the vehicle is in a state which is suited for rewriting the data on condition when the logical AND conditions are satisfied, such as a preset time has elapsed from the moment when the engine rotational speed has become 0 and the voltage of the vehicle-mounted battery is not lower than a preset lower-limit value. Even under such conditions, the vehicle is in a state of lower limit which is necessary for properly rewriting the data.

The fact that the preparation for rewriting the data is completed may be reported to the user by transmitting a mail (E-mail) to a cell phone that has been registered in advance irrespective of whether the user is seated on the seat.

The user may be reported in various other ways such as controlling the door lock or turning on the hazard lamps based on such recognition that a smart card key is located near the vehicle.

Canceling the rewriting of data by the user is convenient from the standpoint of maintaining a chance of utilizing the vehicle by the user, though the cancellation needs not necessarily be requested.

The engine control system 110 need not necessarily be equipped with the timer 115. In this case, however, rewriting the data is executed according to the above quaternary processing (step S4) at a moment when rewriting the data is instructed by the user.

After the rewrite data stored in the memory unit 143 are determined to be proper, the write preparation completion report processing (step S300) may be executed at any timing and in any number of times (not less than one time).

The operation for instructing the rewriting of data may not be the condition for starting the rewriting of data in the engine control system 110 (quaternary processing). For example, a timer time may be set in advance to the timer 146, and the data may be rewritten when the master control system 140 is driven by the timer 146 on condition that the rewrite data stored in the memory unit 43 are determined to be proper.

The rewrite data stored in the memory unit 143 may be deleted, or the rewrite data that are deleted may be received again at timings other than when the Ignition switch is turned on based on the communication interruption history stored in the backup RAM.

Verification can be checked in a unit of any data length.

The primary processing flag, secondary processing flag, and tertiary and quaternary processing flags may be held by any means inclusive of the memory unit 143 so far as they are operated in a form exemplified in FIG. 5 above. Further, various kinds of history information (communication interruption history, etc.) may similarly be held by any means inclusive of the memory unit 143 so far as they are held in a nonvolatile manner which is writable/erasable.

When the engine control program memory 113 and the rewrite control program memory 114 are constructed with electrically rewritable nonvolatile memories such as EEPROMs, the control unit 111 in the engine control system 110 in the after-processing may store, in these memories 113 and 114, the data such as learned values that are to be held until the operation of the next time.

The above processing (rewrite preparation completion report processing, etc.) based on the operation of the Ignition switch may be executed based on the operation of a separate key switch such as an accessory switch.

The master control system 140 is equipped with the radio communication unit 142 and with the memory unit 143. The radio communication unit 142 and the memory unit 143, however, may be provided for each of the data rewriting control systems. If there is used, as the memory unit 143, a large-scale memory such as a hard disk provided for the data rewriting control system that constitutes, for example, a navigation system, it becomes easy to maintain the capacity of the memory unit 143.

The memory unit 143 may be a rewritable memory which holds the data in a nonvolatile state.

Not being limited to the electronic control systems 110 to 130, any object may be rewritten by the master control system 140. Further, the electronic control systems 110 to 130 may not be the objects for rewriting.

The vehicle-mounted data rewriting control systems of the above embodiments can further be applied to those which execute the communication between the two electronic control systems through a dedicated communication line.

The rewrite data supplied through radio communication are temporarily stored in the memory unit 143, and the stored rewrite data are determined for their properness. The reliability in rewriting the data can be further improved while enhancing the degree of freedom concerning the timing for obtaining the rewrite data supplied through radio communication and concerning the timing for rewriting if it is a vehicle-mounted data rewriting control system that rewrites (reprograms) the data in the data rewriting control system for which the data are to be rewritten by using the rewrite data on condition that the stored rewrite data are proper. In this sense, the state of feeding the electric power from the vehicle-mounted battery needs not necessarily be maintained for a period of time needed for the data communication based on the turn off of the key switch of the vehicle during the communication with the management center 200. Further, the nonvolatile memory does not necessarily have to hold the communication interruption history representing the interruption of electric power, which is based on the interruption of electric power from the vehicle-mounted battery during the communication with the management center 200.

What is claimed is:

1. A vehicle-mounted data rewriting control system, which is constructed as to rewrite, based upon rewrite data supplied from an external unit through radio communication, at least either a control program or control data for controlling vehicle-mounted equipment stored in a rewritable region of a nonvolatile memory, comprising:
storage means for temporarily storing the rewrite data at time of rewriting at least either the control program or the control data;
determining means for determining properness of the rewrite data stored in the storage means; and
rewrite control means for rewriting at least either the control program or the control data by using the rewrite data on condition that the rewrite data stored in the storage means are determined by the determining means to be proper.

2. The control system according to claim 1, wherein:
the determining means determines the properness of the rewrite data based upon checking verification of the rewrite data stored in the storage means and of verification data corresponding to the rewrite data.

3. The control system according to claim 2, wherein:
the verification is checked at the external unit based upon the rewrite data stored in the storage means and sent back; and
the determining means determines the properness of the rewrite data stored in the storage means based upon information transmitted from the external unit as a result of checking the verification.

4. The control system according to claim 2, wherein:
the verification is checked based upon the rewrite data stored in the storage means and upon the data transmitted again from the external unit as corresponding to the data; and
the determining means determines the properness of the rewrite data stored in the storage means by making a direct reference to a result of checking the verification.

5. The control system according to claim 3, wherein:
the communication with the external unit is a packet communication, and the verification is checked in a unit of data that are divided in a unit of packet.

6. The control system according to claim 3, wherein:
the verification is checked in a unit of a data length of the rewrite data stored in the storage means.

7. The control system according to claim 1, wherein:
a state of feeding electric power from a vehicle-mounted battery is maintained for a period of time necessary for data communication based upon a turn-off of a key switch of the vehicle during communication with the external unit.

8. The control system according to claim 1, further comprising:
means for holding, in a nonvolatile memory, history information representing interruption of electric power based on the interruption of electric power during the communication with the external unit.

9. The control system according to claim 8, further comprising:
means for deleting the data stored in the storage means and for receiving again the deleted data based on the history information held in the nonvolatile memory when the key switch of the vehicle is turned on.

10. The control system according to claim 1, further comprising:
a timer for automatically starting a data rewriting control operation based on elapse of a preset timer time,
wherein, when the data rewriting control operation is started by the timer, the rewrite control means rewrites at least either the control program or the control data on condition that the rewrite data stored in the storage means are determined to be proper.

11. The control system according to claim 1, further comprising:
reporting means for reporting a user of state of waiting for rewriting of either the control program or the control data by the rewrite control means based on the rewrite data stored in the storage means that are determined to be proper,
wherein the rewrite control means rewrites at least either the control program or the control data based on a reported operation for instructing the rewriting of at least either the control program or the control data.

12. The control system according to claim 11, wherein:
when at least either the control program or the control data has not been rewritten by the rewrite control means, the reporting means issues the notice again at least either when the key switch of the vehicle is turned off or when the key switch is turned on.

13. The control system according to claim 11, wherein:
when the rewriting of at least either the control program or the control data is instructed, the reporting means further issues the notice requesting to inhibit the operation of a vehicle engine.

14. The control system according to claim 11, further comprising:
a timer of which a timer time is set based on a notice from the reporting means that execution of rewriting is standing by and which automatically operates data rewriting control operation based on elapse of the preset timer time,
wherein, when the data rewriting control operation is started by the timer, the rewrite control means rewrites at least either the control program or the control data on condition that the rewrite data stored in the storage means are determined to be proper.

15. The control system according to claim 14, wherein:
a diagnosis of a trouble in vehicle-mounted equipment is inhibited, when the rewrite data stored in the storage means are determined to be proper at a moment when the data rewriting control operation is started by the timer.

16. The control system according to claim 14, wherein:
when a cancel of the rewriting of at least either the control program or the control data is instructed in response to the notice of the reporting means that the execution of rewriting is standing by, the rewrite control means postpones the rewriting of at least either the control program or the control data started by the timer.

17. The control system according to claim 11, wherein:
the reporting means issues the notice by transmitting a mail to a cell phone that has been registered in advance.

18. The control system according to claim 11, wherein:
the reporting means issues the notice through a display on a screen of a navigation system.

19. The control system according to claim 1, wherein:
in rewriting at least either the control program or the control data by the rewrite control means, it is determined for start whether a state of the vehicle is suited for rewriting at least either the control program or the control data; and
the rewrite control means starts rewriting at least either the control program or the control data by using the rewrite data stored in the storage means when it is determined that the vehicle is in the state suited for rewriting.

20. The control system according to claim 19, wherein:
the rewrite control means determines a start based upon whether a logical AND conditions including that a preset time has been elapsed from a moment when a rotational speed has become 0 accompanying a halt of operation of a vehicle engine and a voltage of a vehicle-mounted battery is larger than a preset lower-limit value; and
it is determined that the state is suited for the rewriting when the logical AND conditions are satisfied.

21. The control system according to claim 1, wherein:
a plurality of electronic control systems is provided to execute data rewrite control operation in a divided manner, the plurality of electronic control systems being connected to each other through a communication bus that constitutes a LAN in the vehicle; and
any one of the electronic control systems is provided with, in addition to the storage means, communication means for communication with the external unit.
